(19) United States
(12) Patent Application Publication
(10) Pub. No.: US 2020/0180610 A1
(43) Pub. Date: Jun. 11, 2020

(54) METHOD FOR THE AT LEAST PARTIALLY AUTOMATED OPERATION OF A VEHICLE

(71) Applicant: ZF Active Safety GmbH, Koblenz (DE)

(72) Inventors: Georg Schneider, Urbar (DE); Thomas Mueller, München (DE)

(21) Appl. No.: 16/702,634

(22) Filed: Dec. 4, 2019

(30) Foreign Application Priority Data
Dec. 7, 2018 (DE) 102018131466.3

(51) Int. Cl. B60W 30/09; B60W 40/04; B60W 40/105; B60W 30/095; G05D 1/00

(52) U.S. Cl. CPC B60W 30/09; B60W 40/04; B60W 40/105; G05D 2201/0213; G05D 1/0088; B60W 2550/30; B60W 2550/10; B60W 30/0956

(57) ABSTRACT

In a method for the at least partially automated operation of a vehicle, a driving maneuver target is determined based on a predetermined route, a traffic situation is detected using a sensor system, for the detected traffic situation, under the specification of the driving maneuver target and multiple driving maneuver limits, a standard driving maneuver is determined based on the detected traffic situation, an anomaly indicator for the traffic situation is determined from at least one situation feature, and an exception driving maneuver is determined when a threshold value for the anomaly indicator is exceeded.

### BACKGROUND OF THE INVENTION

The invention relates to a method for the at least partially automated operation of a vehicle, in particular a wheeled vehicle such as a passenger vehicle or a truck.

For liability and safety reasons, systems for operating vehicles in a partially, highly, or completely automated manner are generally designed in such a way that legal or official requirements are met. In situations in which no suitable maneuver that meets the requirements can be determined in an automated manner, and no manual intervention by a vehicle occupant takes place, a secure state brought about by the automatically operated vehicle is provided.

In particular in uncommon or complex traffic situations, such as traffic signs that are intentionally misplaced, accident events, or behavior of other road users that does not conform to regulations, as well as situations with limited detection of the surroundings, prompting to manually control the vehicle and to possibly place the vehicle in a secure state is to be expected more often. In particular, in this regard the wide range of possible driving actions in manually operated vehicles, including aggressive and improper maneuvers, represents a challenge.

The increasing prevalence of assistance and automation functions is accompanied by an increase in the expectations for such systems by customers, who perceive a prompt for manual control as a system weakness and a source of annoyance.

### SUMMARY OF THE INVENTION

The object of the invention is to overcome the disadvantages of the prior art, in particular to provide a method for the at least partially automated operation of a vehicle, having a high level of when operated together with manual vehicles.

This object is achieved by the method of independent claim 1. Accordingly, in a method for the at least partially automated operation of a vehicle, a driving maneuver target is determined based on a predetermined route, a traffic situation is detected using a sensor system, for the detected traffic situation, under the specification of the driving maneuver target and multiple driving maneuver limits, a standard driving maneuver is determined based on the detected traffic situation, an anomaly indicator for the traffic situation is determined from at least one situation feature, and an exception driving maneuver is determined when a threshold value for the anomaly indicator is exceeded.

A standard driving maneuver complies with all stipulated driving maneuver limits, and moves the vehicle corresponding to the driving maneuver target. In particular driving situations, the result of the determination is that no standard driving maneuver can be found that corresponds to the driving maneuver target and all driving maneuver limits. The vehicle would then have to be brought into a secure state, for example stopping on the roadside or remaining in the current position. The analysis of the traffic situation, detected by the sensor system, for certain situation features allows traffic situations to be detected in an automated manner, in which although no standard maneuver can be determined, an exception maneuver with consideration of the traffic situation is possible, which, although it does not meet the specifications for a standard maneuver, it is obvious to a reasonable and informed driver. The unsatisfactory situation is thus avoided that the vehicle is brought into a secure state, or does not behave in the way that a reasonable driver would operate the vehicle in view of the traffic situation.

The vehicle surroundings detected via the surroundings sensor system are examined for situation features. With regard to a traffic situation that results from multiple situation features, deviating situation features are searched and represented in an anomaly indicator, taking into account the type and extent of the deviation. An exception driving maneuver is determined when the anomaly threshold value is exceeded.

The exception driving maneuver differs from a standard driving maneuver in that during the determination, by reducing or completely deactivating one or more driving maneuver limits a driving maneuver may be determined that cannot be considered as a standard maneuver due to the fact that it contains limitations regarding driving comfort or violates a traffic regulation.

A determined standard driving maneuver or exception driving maneuver may include a specific trajectory according to which a vehicle actuator system controller controls lateral and longitudinal acceleration of the vehicle, or also only maneuver specifications such as route points, vehicle dynamics parameters, and areas to be traveled or avoided, which are transmitted to a trajectory planning module which then computes a trajectory, taking the specifications into account.

According to one preferred embodiment, when the threshold value is exceeded, the instantaneously detected traffic situation is compared to multiple traffic situations present in a memory, based on the at least one situation feature. In particular, the traffic situations present in the memory are defined by multiple situation features. A traffic situation is preferably recognized based on a partial match of the situation features associated with a traffic situation in the memory.

According to one preferred embodiment, the at least one situation feature includes one or more of the following features: An absolute position of the vehicle; a speed of the vehicle; an estimated time until the driving maneuver target is attained; the number of vehicles that pass the vehicle per unit time; a traffic density indicator; recognized objects and their respective object class; a longitudinal and/or lateral distance profile concerning one or more other objects in the traffic situation; a reliability indicator concerning the recognition of objects in the traffic situation; the number and position of detected lanes; a roadway width; and one or more detected traffic signs. The above-mentioned situation features allow numerous traffic situations to be described and once again recognized in an automated manner.

In particular, for this purpose situation features or a minimum distance traveled by the vehicle are analyzed and/or correlated over a period of several seconds, preferably greater than 10 seconds.

According to one preferred embodiment, the exception driving maneuver is determined according to a smaller number of driving maneuver limits, based on the detected traffic situation. With the reduction in the driving maneuver limits, further driving maneuvers are possible, thus avoiding the vehicle being placed in a secure state and the trip being interrupted. In particular, a user confirmation is required for carrying out exception driving maneuvers that violate a traffic regulation.

According to one preferred embodiment, the exception driving maneuver is determined by retrieving an exception driving maneuver, associated with the predetermined traffic situation, from a memory containing earlier exception driving maneuvers. This ensures that the vehicle functions in a similar way in comparable situations. In addition, an exception driving maneuver that is already present is directly retrievable, which is advantageous in traffic situations that require a quick response. Alternatively, the exception driving maneuver is determined in the same way as the standard driving maneuver, for example via an optimization process.

According to one preferred embodiment, the instantaneous traffic situation is stored in a memory as a predetermined traffic situation when a storage condition is present. In particular, the storage condition includes one or more of the following conditions: The vehicle is being driven by a person in the instantaneous traffic situation, in particular a deviation between the determined standard driving maneuver and the personally carried out maneuver being detected; a minimum acceleration threshold of the vehicle is exceeded; a minimum steering rate threshold of the vehicle is exceeded; a memory operation is carried out by an occupant of the vehicle.

According to one preferred embodiment, when a threshold value for a driving parameter is exceeded or undershot, a vehicle actuator system is actuated according to a predetermined emergency maneuver. An evasion maneuver or full braking maneuver may be provided as an emergency maneuver. An emergency maneuver is triggered in particular when a predicted time of collision with an obstacle in front of the vehicle undershoots a minimum time. A driving actuator system controller preferably assigns higher priority to a predefined exception driving maneuver than to a standard driving maneuver, and/or assigns higher priority to an emergency maneuver than to an exception driving maneuver. This ensures that a safety-relevant driving maneuver is carried out by the vehicle under all operating conditions.

According to one preferred embodiment, for determining the exception maneuver based on the traffic situation, only information concerning the traffic situation that is detected by the vehicle sensor system is taken into account. In particular, for determining the traffic situation and the anomaly indicator, situation features are analyzed which are [based] on vehicle sensor system-based information and information generated external to the vehicle, such as information generated by infrastructure, other vehicles, or traffic data providers. By processing exclusively by means of a vehicle-based sensor system, such as a camera, lidar, radar, an ultrasonic sensor system, or a vehicle dynamics sensor system, this ensures that the exception maneuver is determined from actually measured sensor data, and when there are potential inconsistencies between external surroundings data and vehicle sensor data, the measured surroundings data are given priority.

According to one preferred embodiment, in a mode for the automated operation of the vehicle, a vehicle actuator system for implementing the standard driving maneuver is actuated, and as soon as an exception driving maneuver has been determined, the vehicle actuator system is actuated in order to implement the exception driving maneuver.

According to one preferred embodiment, for determining the exception driving maneuver an exception driving maneuver target is predefined, wherein an exception driving maneuver target is determined from the route with a higher location deviation tolerance than for the driving maneuver target. For example, a driving maneuver target is selected from possible positions that are located on the lane being traveled on by the vehicle at that moment and that are on the route, while for an exception driving maneuver, an exception driving maneuver target is selected from any arbitrary positions located on the route.

According to one preferred embodiment, a traversable space from the detected traffic situation is determined, and the exception driving maneuver is determined according to a randomly selected target in the traversable space. The selection of possible exception driving maneuvers is thus further increased, and the risk of an interruption of the automated trip is decreased.

### BRIEF DESCRIPTION OF THE DRAWINGS

Further features, advantages, and characteristics of the invention are explained based on the description of preferred embodiments of the invention, with reference to the figures, which show the following:

FIG. 1: shows a traffic situation in which the method according to the invention is used; and

FIG. 2: shows a schematic illustration of the method steps of the method according to the invention.

### DESCRIPTION

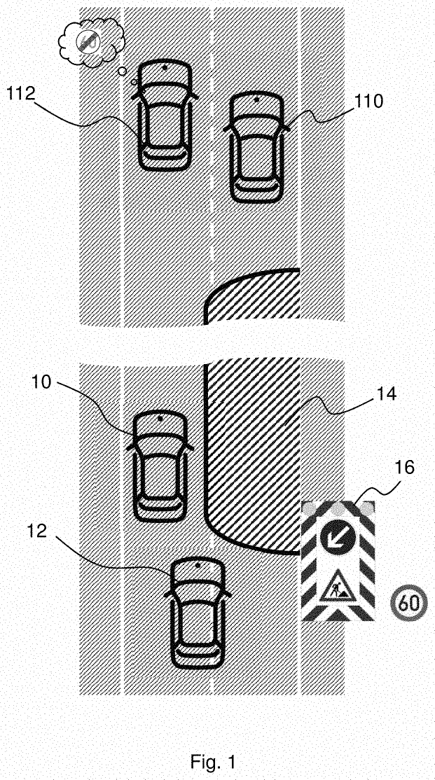

FIG. 1 shows a typical traffic situation on a two-lane roadway. A construction zone 14 is indicated by means of a display board 16, which sets a maximum speed of 60 kilometers per hour for the construction zone 14. A vehicle 10 that is equipped for at least partial automated operation detects, by means of a camera sensor system, the display board 16 and evaluates it. As a result, the systems for automated driving of the vehicle 10 take into account the maximum speed of 60 kilometers per hour for all of the driving maneuvers that follow.

In the example in FIG. 1, provision of the sign that once again raises the speed limit has been inadvertently omitted. In other situations, the sign for raising the speed limit could be concealed by another vehicle, or might not be detectable due to weather.

With a conventional driver assistance system such as cruise control with traffic sign recognition, the vehicle 10, which at a later point in time is illustrated as vehicle 110, continues to travel at the most recently detected maximum speed of 60 kilometers per hour, at least until the next increase in the maximum speed according to traffic regulations. As an example, a vehicle 12 that is driven exclusively by a person is shown, which after leaving the construction zone is illustrated as vehicle 112, in which the vehicle driver recognizes the end of the construction zone 14 and accelerates despite the lack of a sign advising that the speed limit has been discontinued. The automatically operated vehicle 110 is thus passed by the person-driven vehicle 112.

According to the method according to the invention, it is provided that the vehicle 10 detects a traffic situation using a surroundings sensor system, in particular a camera sensor system. Multiple situation features are evaluated for this purpose. Moving and nonmoving objects in the vehicle surroundings are detected and classified by means of the surroundings sensor system. The classified objects are kept in a situation memory and analyzed in order to check predetermined situation features.

In the example, for example the frequency of guide beacons, the presence of a roadway barrier, and/or a reduced lane width are/is used as a situation feature for the construction zone. In particular, multiple situation features are extracted from the classified objects and correlated with respect to time. If the situation features comprising frequent guide beacons and/or reduced lane width are absent, a check is made as to whether situation features that indicate the most recently detected situation are likewise absent within a predetermined time and/or distance.

By use of a camera sensor system, the number of lanes is detected and compared to an expected number of lanes based on map data. A match of the detected number of lanes with the expected number of lanes is used as a situation feature for a normal traffic situation. Alternatively or additionally, the course of the lanes is detected and compared to map data.

While an expected traffic situation after appearance of the sign 16 is initially confirmed for the vehicle 10 based on the situation features, situation features that are typical of a construction site are absent after the end of the construction zone 14. The objects detected and classified in the surroundings are continuously checked for situation features, so that situation features are additionally present which are typical for a normal traffic situation. In particular, the positions of landmarks such as signs are checked for agreement with positions that are expected according to map data.

By comparison with predetermined combinations of situation features, a check is made as to whether a traffic situation instantaneously detected in the surroundings can be unambiguously classified. If individual situation features differ from the classified situation, an anomaly indicator is increased. If the anomaly indicator undershoots a threshold value, the situation analysis is continued without the need for additional method steps. According to the method, a standard driving maneuver is then determined, based on the detected traffic situation. The predetermined driving maneuver limits, such as vehicle dynamics limits, driving comfort limits, traffic regulations, and/or safety limits are hereby taken into account. The standard driving maneuver is planned, for example, by means of an optimization process according to the driving maneuver target, with inclusion of the driving maneuver limits as boundary conditions. The driving maneuver target is derived from a route which may be specified by a navigation system.

In the example in FIG. 1, the situation features that indicate the construction zone 14 are absent, but due to the most recently detected traffic sign, the maximum speed specification remains as the specification for the automated operation of the vehicle 110. The deviation of the maximum speed specification from the speed specification that is expected according to the classified traffic situation, namely, the maximum speed according to map data after the end of the construction zone 14, increases the anomaly indicator.

If the anomaly indicator exceeds a threshold value, according to the method an exception driving maneuver is determined. In particular, the situation features resulting in an increase in the anomaly indicator are evaluated in order to determine a suitable exception driving maneuver. For example, if there is a large deviation between the maximum speed provided according to map data and the maximum speed detected according to surroundings data, an exception driving maneuver is determined, and the maximum speed detected according to surroundings data is disregarded.

Alternatively or additionally, the combination of situation features that is present is compared to combinations of situation features that are stored in a memory. If a previously stored combination of situation features is recognized, a predetermined exception driving maneuver may be retrieved from the memory.

In one embodiment not illustrated in greater detail, the exception driving maneuver is carried out manually during person-driven operation of the vehicle, and is stored in the memory via user input. Alternatively or additionally, the exception driving maneuver is determined by a maneuver analysis of other vehicles with the aid of the surroundings sensor system.

In another situation not illustrated in the figures, an automatically operated vehicle is guided inside two solid lane markings, for example in a construction zone. If the lane is blocked by a nonoperational vehicle, the particular traffic situation is defined by means of the anomaly indicator and the analysis of situation features such as a large difference between the actual speed and the expected speed. For determining an exception driving maneuver, driving maneuver limits are reduced as a function of the anomaly-determining situation features. The exception driving maneuver is determined by optimization, while omitting the boundary conditions of the lane markings. Alternatively or additionally, a different driving maneuver target is derived from the predetermined route. In particular, the driving maneuver target is less satisfactory with regard to evaluation criteria for a standard driving maneuver.

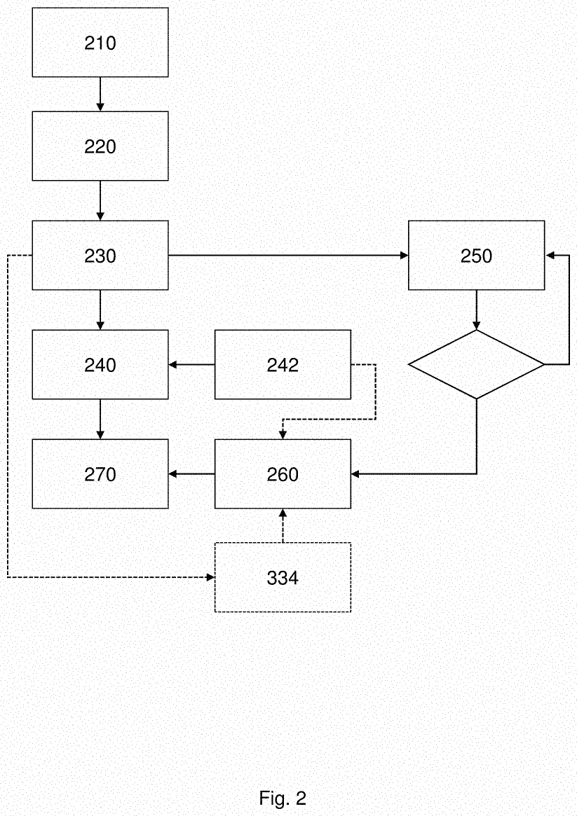

The sequence of the method according to the invention is illustrated in detail in FIG. 2. A driving maneuver target is determined from a predetermined route in the first step 210. The predetermined route is determined, for example, by a navigation system of the automatically operated vehicle, based on a trip destination specified by the vehicle user.

The vehicle is operated in an automated manner, corresponding to the route, in subsequent step 220. The surroundings sensor system, which detects a position of the vehicle along the route as well as static and dynamic objects present in the surroundings of the vehicle, is used for the automated operation.

Situation features are formed in step 230, based on the detected objects and the position of the vehicle, in particular based on the entirety of the available vehicle information. Also included in particular are the type of street traveled on, traffic signs, lane markings, other vehicles and road users, guide beacons, guard rails, traffic lights, traffic information communicated via data networks, vehicle dynamics data of the vehicle, and motion data of the detected objects obtained by the surroundings sensor system. Based on the detected data, situation features such as passing frequency, traffic density, lane width, absolute and/or relative position of the vehicle, speed and/or change in speed of the vehicle, estimated time to attain the driving maneuver target, longitudinal and/or lateral distance profile with regard to one or more objects in the surroundings of the vehicle, are assigned to reliability indicators concerning the recognition of objects and/or situation features.

Regardless of whether the anomaly indicator exceeds a threshold value or whether a traffic situation can be unambiguously classified based on the situation features, in step 230 a standard driving maneuver is determined according to the driving maneuver target, taking into account a predetermined set of driving maneuver limits. The driving maneuver limits demarcate the determinable driving maneuver according to a desired comfort level within preferred ranges for longitudinal acceleration, lateral acceleration, and/or yaw rate, maneuvers that are actually possible according to a vehicle dynamics model, according to predefined safety distances from other objects, and according to traffic regulations. The driving maneuver limits demarcate the solution space for possible standard driving maneuvers. Due to this fact, in particular situations it is not possible to determine a standard driving maneuver, so that the vehicle is guided into a secure state or a manual control intervention by the vehicle occupant is required.

The situation features derived from the surroundings data are comprehensively and continuously analyzed as to whether a predetermined class of traffic situations is present. A class of traffic situations may be formed by certain value ranges for situation features and combinations of situation features. In one alternative embodiment which in other respects is the same as the method described above, a neural network is trained to classify traffic situations and is used in the method for classifying situation features. When certain situation features occur, according to step 250 an anomaly indicator is computed and compared to a predefined threshold value. If the anomaly indicator does not exceed the threshold value, the analysis of the situation features and the anomaly indicator computation are continued. If the anomaly indicator exceeds the threshold value, an exception maneuver is determined in step 260. During the determination of the exception maneuver, driving maneuver limits are selectively deactivated. In other respects, the evasion maneuver in particular is determined the same way as for the standard maneuver. According to the present situation features individual driving maneuver limits such as individual traffic regulations, or entire groups of driving maneuver limits are deactivated, so that the driving maneuver limits represented by step 242 do not affect, or only partially affect, the determination of the exception maneuver, as illustrated by a dashed-line arrow.

Alternatively or additionally, as indicated by the dashed-line arrows and step 334, a predetermined exception maneuver for a predetermined traffic situation is selected from a memory, based on the situation features.

As a result of the increased solution space for potential driving maneuvers, it is thus possible to determine an exception driving maneuver, so that transmitting a control request to the vehicle occupant or guiding the vehicle into a secure state is avoided.

The standard maneuver determined in step 240 and the exception driving maneuver determined in step 260 are relayed to a travel controller which according to step 270 converts the maneuver specifications into an actual driving maneuver. In step 270 the travel controller prioritizes an exception driving maneuver over a standard maneuver.

### LIST OF REFERENCE NUMERALS

10 host vehicle
12 vehicle
14 construction site
16 traffic sign
101 host vehicle
121 vehicle

1. A method for the at least partially automated operation of a vehicle, wherein a driving maneuver target is determined based on a predetermined route,
a traffic situation is detected using a sensor system,
for the detected traffic situation, under the specification of the driving maneuver target and multiple driving maneuver limits, a standard driving maneuver is determined based on the detected traffic situation,
an anomaly indicator for the traffic situation is determined from at least one situation feature, and an exception driving maneuver is determined when a threshold value for the anomaly indicator is exceeded.

2. The method according to claim 1, wherein when the threshold value is exceeded, the instantaneously detected traffic situation is compared to multiple traffic situations present in a memory, based on the at least one situation feature.

3. The method according to claim 2, wherein the at least one situation feature includes one or more of the following features:
an absolute position of the vehicle;
a speed of the vehicle;
an estimated time until the driving maneuver target is attained;
the number of vehicles that pass the vehicle per unit time;
a traffic density indicator;
a longitudinal and/or lateral distance profile concerning one or more other objects in the traffic situation;
a reliability indicator concerning the recognition of objects in the traffic situation.

4. The method according to claim 1, wherein the exception driving maneuver is determined according to a smaller number of driving maneuver limits, based on the detected traffic situation.

5. The method according to claim 1, wherein the exception driving maneuver is determined by retrieving an exception driving maneuver, associated with the predetermined traffic situation, from a memory containing earlier exception driving maneuvers.

6. The method according to claim 1, wherein the instantaneous traffic situation is stored in a memory as a predetermined traffic situation when a storage condition is present.

7. The method according to claim 6, wherein the storage condition includes one or more of the following conditions:
the vehicle is being driven by a person in the instantaneous traffic situation, in particular a deviation between the determined standard driving maneuver and the personally carried out maneuver being detected;
a minimum acceleration threshold of the vehicle is exceeded;
a minimum steering rate threshold of the vehicle is exceeded;
a memory operation is carried out by an occupant of the vehicle.

8. The method according to claim 1, wherein when a threshold value for a driving parameter is exceeded or undershot, a vehicle actuator system is actuated according to a predetermined emergency maneuver.

9. The method according to claim 1, wherein for determining the exception maneuver based on the traffic situation, only information concerning the traffic situation that is detected by the vehicle sensor system is taken into account.

10. The method according to claim 1, wherein in a mode for the automated operation of the vehicle, a vehicle actuator system for implementing the standard driving maneuver is actuated, and as soon as an exception driving maneuver has been determined, the vehicle actuator system is actuated in order to implement the exception driving maneuver.

11. The method according to claim 1, wherein the exception driving maneuver is carried out according to an exception driving maneuver target, wherein an exception driving maneuver target is determined with a higher location deviation tolerance than for the driving maneuver target.

12. The method according to claim 1, wherein a traversable space from the detected traffic situation is determined, and the exception driving maneuver is determined according to a randomly selected target in the traversable space.
